(19) United States
(12) Patent Application Publication
(10) Pub. No.: US 2016/0269919 A1
(43) Pub. Date: Sep. 15, 2016

(54) Procedures for Class-based Measurements on Multiple Carriers

(71) Applicant: TELEFONAKTIEBOLAGET L M ERICSSON (PUBL), Stockholm (SE)

(72) Inventors: Muhammad Kazmi, Bromma (SE); Torgny Palenius, Barsebäck (SE)

(21) Appl. No.: 14/399,998

(22) PCT Filed: Sep. 26, 2014
(86) PCT No.: PCT/SE2014/051121

§ 371 Date: Nov. 10, 2014

Related U.S. Application Data
(60) Provisional application No. 61/884,373, filed on Sep. 30, 2013.

(51) Int. Cl. H04W 24/08

(52) U.S. Cl. CPC H04W 24/08; H04W 84/045

(57) ABSTRACT

Techniques are provided for facilitating radio measurements when the number of carriers to be measured is increased. An example method, in a network node, includes determining at least a first set and second set of carrier frequencies to be used by the radio communication device for performing radio measurements on cells operating on the said carrier frequencies, where the radio measurements to be performed on cells on the first set of carriers are required to meet a first set of pre-defined requirements and radio measurements of the same type performed on cells on the second set of carriers are required to meet a second set of pre-defined requirements, and where the first set of pre-defined requirements are more stringent than the second set. The method further includes sending information to the radio communication device identifying the determined first and second sets, to enable class-based measurements on the identified carrier frequencies.

### TECHNICAL FIELD

The present disclosure is generally related to wireless communications networks and is more particularly related to methods and apparatus for performing mobility measurements on multiple carriers associated with multiple radio-access technologies.

### BACKGROUND

The 3^{rd}-Generation Partnership Project (3GPP) is continuing to develop new features and new capabilities for the wireless communications radio access technologies known as the Universal Terrestrial Radio Access Network (UTRAN), which includes the radio access technologies (RATs) commonly known as Wideband Code-Division Multiple Access (WCDMA) and High-Speed Packet Access (HSPA), and the Evolved Universal Terrestrial Radio Access Network (E-UTRAN), the radio access network (RAN) portion of which is commonly referred to as Long-Term Evolution (LTE).

In addition to the addition and evolution of features and capabilities, the number of frequency bands defined for UTRAN and E-UTRAN is increasing. Since there are more carriers available and the traffic is increasing, the number of carriers an operator might be using in any given area is also increasing.

According to the current UTRAN specifications, a UE is required to be able to perform measurements on cells distributed on at least two inter-frequency carriers, in addition to measuring cells on the serving carrier frequency, which may be referred to as the intra-frequency carrier. This requirement limits the “equal” usage of all available carriers that operators may have in practice. However, this limitation can cause problems when an operator wishes to deploy low power node cells (e.g., pico-cells or femto-cells) on a separate carrier, which may be referred to as a “dedicated” carrier in this context.

A “carrier frequency” or “carrier” or simply “frequency” may also be referred to as a “frequency layer” or simply “layer.” Each GSM carrier has a bandwidth of 200 KHz, whereas in UMTS and LTE the carrier frequency is much wider, e.g., 1.4 MHz or more in LTE and 5 MHz in UMTS. Also, in GSM, the Broadcast Control Channel (BCCH) carrier, which enables identification of a GSM cell, is reused in every n-th GSM cell, e.g., every third or every 12th GSM cell. In LTE and UMTS, on the other hand, the carrier frequency is reused in every cell. Therefore, in GSM each GSM carrier is also regarded as a GSM cell. For this reason, in 3GPP LTE specifications the GSM layer includes 32 GSM carriers. For other RATs, a layer corresponds to the carrier frequency. For example, if the UE is configured to measure on cells of one UMTS carrier frequency, cells of one LTE FDD carrier frequency, and up to 32 GSM cells, then, according to the 3GPP specification, the UE is assumed to be configured for measurements on three frequency layers. Measuring on several carriers at the same or overlapping time is also called as multiple layer monitoring or measurement. The term monitoring herein refers to performing one or more measurements on one or more carrier frequencies.

According to the current E-UTRAN specifications, a UE is required to be able to perform measurements on cells distributed on at least three inter-frequency carriers, whether the UE is operating in frequency-division duplexing (FDD) mode or time-division duplexing (TDD) mode, in addition to the cells on the serving carrier frequency. Again, this is a significant limitation, given the amount of spectrum that operators typically have and the increased interest in advanced deployment scenarios like heterogeneous network as described below.

In both UTRAN and E-UTRAN specifications there are also limitations in terms of the total number of carriers that the UE is required to measure. In both systems, the UE is required to measure in total up to seven non-serving carriers, including inter-frequency and inter-RAT carriers. This requirement is specified for measurements in low-activity Radio Resource Control (RRC) states (idle state, idle mode, CELL_PCH state, URA_PCH state, etc.), as well as in high-activity RRC states (e.g., connected, CELL_DCH, and CELL_FACH states). Examples of inter-RAT carriers in UTRAN FDD belong to GSM/GERAN, UTRA TDD, E-UTRA FDD and E-UTRA TDD systems. Examples of inter-RAT carriers in E-UTRAN FDD belong to GSM/GERAN, UTRA FDD, UTRA TDD, E-UTRA TDD, CDMA 2000 and HRPD systems.

A heterogeneous network is based on a multilayered deployment of a high power node (HPN), such as a macro base station (BS), which can be a wide-area BS serving a macro cell, and one or more low power nodes (LPN), such as a pico-BS, e.g., a local-area BS serving a pico cell that may have a coverage area partially or completely overlapping the coverage area of the HPN. Other examples of LPNs include the home BS, a serving femto cell, and a medium range BS serving a micro cell. An HPN and one or more LPNs in its coverage area may operate on the same frequency, in which case the deployment may be referred to as a co-channel heterogeneous deployment, or on different frequencies, in which case the deployment may be referred to as an inter-frequency or multi-carrier or multi-frequency heterogeneous deployment.

In a heterogeneous deployment using several carriers, there may be no possibility to add neighbor cell information for a new LPN in the macro network, in the event that two of the inter-frequencies are already used in the macro network. This means that the mobile will not perform cell-reselection or any kind of cell change (e.g., handover) when entering the coverage of the LPN.

Based on these new deployment scenarios and the acquisition of additional spectrum, wireless network operators are greatly interested in increasing the number of carriers that the UE is able to measure. Increasing the existing numbers is also desirable for network planning purposes. However, drawbacks in increasing the number of carriers that UEs are able to measure include an increase in UE complexity and/or longer delays between measurement occasions. Longer delays between measurement occasions will increase the reaction time when a UE enters the coverage of any inter-frequency cells. Any delay in cell change is undesirable, as it causes performance loss or even the dropping of calls.

### UE Measurements

To support different functions such as mobility (e.g., cell selection, cell reselection, handover, RRC re-establishment, connection release with redirection, etc.), minimization of drive tests, self-organizing networks (SON), positioning, etc., the UE is required to performed one or more measurements on signals transmitted by neighboring cells. The UE receives measurement configuration or an assistance data/information, which is a message or an information element (IE) sent by the network node (e.g., serving eNode B, positioning node, etc.) to configure UE to perform the requested measurements. The measurement configuration information or assistance data may contain information related to the carrier frequency or frequencies to be measured, one or more RATs to be measured, one or more types of measurements to be made (e.g., reference signal received power, or RSRP), higher layer time-domain filtering to be applied to the measurements, measurement bandwidth-related parameters, etc.

The measurements are done by the UE on the serving cell as well as on neighbor cells, over some known reference symbols or pilot sequences. The measurements may be done on cells on the intra-frequency carrier, one or more inter-frequency carriers, as well as on inter-RAT carriers, depending upon whether the UE supports the RAT or RATs for neighboring carriers.

The measurements are done by the UE in RRC connected state or in CELL_DCH state (in HSPA), as well as in low-activity RRC states (e.g., idle state, CELL_FACH state in HSPA, URA_PCH and CELL_PCH states in HSPA, etc.).

To enable inter-frequency and inter-RAT measurements in RRC connected state in E-UTRAN and UTRAN, the network has to configure measurement gaps. It should be noted that in UTRAN the RRC connected state may further comprise of either Cell_DCH state or Cell_FACH state. Two periodic measurement gap patterns both with a measurement gap length of 6 ms are defined for LTE:
Measurement gap pattern #0 with repetition period of 40 milliseconds; and
Measurement gap pattern #1 with repetition period of 80 milliseconds. In High-Speed Packet Access (HSPA), the inter-frequency and inter-RAT measurements are performed in compressed mode gaps, which are also a type of network-configured measurement gaps.

In both LTE and HSPA there are also UE capabilities that allow the UE to conduct measurements on non-serving carriers (inter-frequency and/or inter-RAT carriers) without measurement gaps. The detailed techniques described below are also applicable to such UE capabilities. In multi-carrier or carrier aggregation (CA) scenarios, the UE may perform the measurements on the cells on the primary component carrier (PCC), as well as on the cells on one or more secondary component carriers (SCCs).

Measurements are done for various purposes. Some example measurement purposes are: mobility, positioning, self-organizing network (SON), minimization of drive tests (MDT), operation and maintenance (O&M), network planning and optimization etc. Examples of positioning measurements are reference signal time difference (RSTD) measurements, which are used for OTDOA in LTE, UE Rx-Tx time difference measurements, and SFN-SFN type 1 and type 2 measurements.

The measurements are typically performed over a relatively long time duration, i.e., on the order of a few hundreds of milliseconds to a few seconds. The same measurements are applicable in single-carrier and carrier aggregation (CA) operation. However in CA, the measurement requirements may be different. For example, the measurement period may be different in CA, i.e., it can be either relaxed (longer) or more stringent (shorter) depending upon whether or not the SCC is activated. This may also depend upon the UE capability, i.e., whether a CA-capable UE is able to perform measurement on SCC with or without gaps.

Examples of mobility measurements in LTE are reference symbol received power (RSRP) measurements and reference symbol received quality (RSRQ) measurements. Examples of mobility measurements in HSPA are common pilot channel received signal code power (CPICH RSCP) measurements and CPICH Ec/No measurements. An example of mobility measurements in GSM/GERAN is GSM carrier RSSI, while examples of mobility measurements in CDMA2000 systems are pilot strength for CDMA2000 1×RTT and pilot strength for High Rate Packet Data (HRPD).

A mobility measurement may also include the detection and/or identification of a cell, which may belong to LTE, HSPA, CDMA2000, GSM, etc. Cell detection comprises identifying at least the physical cell identity (PCI) and subsequently performing the signal measurement (e.g., RSRP) of the identified cell. The UE may also have to acquire the cell global ID (CGI) of a UE.

The radio measurements performed by the UE are used by the UE for one or more radio operational tasks. One such task is reporting the measurements to the network, which in turn may use them for various tasks. For example, in RRC connected state the UE reports radio measurements to the serving node. In response to the reported UE measurements, the serving network node takes certain decisions, e.g., it may send a mobility command to the UE for the purpose of cell change. Examples of cell change are handover (HO), RRC connection re-establishment, RRC connection release with redirection, PCell change in CA, PCC change in CA, etc. In idle or low activity state, an example of cell change is cell reselection. In another example, the UE may directly use the radio measurements, e.g., for performing such tasks as cell selection, cell reselection, etc.

In the 3GPP specifications 3GPP TS 25.133 for UTRAN and 3GPP TS 36.133 for EUTRAN, the rate of inter-frequency measurements is scaled, generally according to the number of inter-frequency and/or inter-RAT carriers the UE is configured to measure on. The specific details of the scaling depend on the UE's state and the RAT. For example, in idle mode when the UE is camping on an UTRAN cell, the maximum required time between measurements is (N_{carrier}−1)*T_{measureFDD}, where N_{carrier} is the number of UTRA FDD neighbor cells. The equations for the maximum time between measurements scale in a similar way for measurements on all other RATs and in the other states with the number of carriers.

The number of frequencies used in wireless networks is increasing because operators have more available spectrum. (See, for example the 3GPP contribution R4-134096, “Maximum number of carriers a UE can monitor in idle mode for UTRA and E-UTRA”, TeliaSonera AB, Telefónica, Deutsche Telekom, Telecom Italia, available at http://www.3gpp.org/ftp/tsg_ran/WG4_Radio/TSGR4_68/Docs/.) Therefore, there is a need to support more inter-frequency carriers and also inter-RAT carrier frequencies on which the UE should perform measurements. Operators therefore want to significantly increase the number of carriers for doing UE measurements in UTRAN and LTE. (See, e.g., R4-134380, “WF on: Maximum number of carriers a UE can monitor in idle mode for UTRA and E-UTRA”, TeliaSonera AB, available at http://www.3gpp.org/ftp/tsg_ran/WG4_Radio/TSGR4_68/Docs/.)

### SUMMARY

Several of the techniques, devices, and systems described herein provide mechanisms to perform measurements when carriers are increased while overall mobility performance is not degraded.

Example embodiments include a method in a network node (e.g., a base station, a radio base station, a base transceiver station, an evolved Node B (eNB), an Node B, a relay node or a positioning node) of configuring a radio communication device (e.g., a UE, a wireless device, a mobile terminal) for performing radio measurements on cells on plurality of carrier frequencies. This example method comprises determining, based on one or more criteria, at least a first set and second set of carrier frequencies to be used by the radio communication device for performing radio measurements on cells operating on the said carrier frequencies, where the radio measurements to be performed on cells on the first set of carriers are required to meet a first set of pre-defined requirements and radio measurements of the same type performed on cells on the second set of carriers are required to meet a second set of pre-defined requirements, and where the first set of pre-defined requirements are more stringent than the second set. The method further includes sending information to the radio communication device identifying the determined first and second sets, for enabling the radio communication device to perform class-based measurements on cells operating on the carrier frequencies in said sets.

In some embodiments, the information identifying the determined first and second sets of carrier frequencies for enabling the radio communication device to perform measurements on cells operating on the said carrier frequencies is included in a measurement configuration message. In some embodiments, the first set of pre-defined requirements includes measurement delays.

Another example method is implemented in a radio communication device (e.g., a UE, wireless device, mobile terminal), and is for performing radio measurements on cells on a plurality of carrier frequencies. This example method includes receiving a message identifying a plurality of carrier frequencies for cells that are to be measured by the radio communication device, and further comprises determining a first measurement requirement to be met for performing radio measurements on cells operating on a first set of the carrier frequencies and a corresponding second measurement requirement to be met for performing radio measurements of the same type on cells operating on a second set of the carrier frequencies, the first measurement requirement being more stringent than the second measurement requirement. The radio communication device performs radio measurements on cells operating on the first and at least the second set of carriers based on the obtained information.

In some embodiments, the radio communication device determines which carrier frequencies are in each of the first and second sets based on one or more characteristics of at least some of the carrier frequencies and a predetermined rule associating the one or more characteristics to the first and second sets. In some other embodiments, the radio communication device determines which carrier frequencies are in each of the first and second sets based on an identification of at least one of the first and second sets included in the message received from the network node.

One advantage of several of the described embodiments is that the UE is able to support an increased number of carriers in UTRAN and E-UTRAN systems with a good mobility for coverage, securing that pagings and calls are not lost. In several embodiments, the UE power consumption is not increased, compared to prior measurement implementations, even though the UE is capable of measuring on more carriers compared to the current specifications.

Other example embodiments and other advantages of the proposed techniques and apparatus will be apparent from the attached figures and the detailed description that follows.

### FIGURES

FIG. 1 illustrates elements of an example LTE wireless network.

FIG. 2 is a block diagram of an example radio communication device, e.g., a user equipment, which may be configured according to some embodiments of the present invention.

FIG. 3 is a block diagram of an example network node, in this case a base station, which may be configured according to some embodiments of the present invention.

FIG. 4 is a block diagram of a Mobility Management Entity (MME) or Serving Gateway (SGW).

FIG. 5 is a process flow diagram illustrating an example method, in a network node, of configuring a radio communication device for performing radio measurements on cells on plurality of carrier frequencies.

FIG. 6 is a process flow diagram illustrating an example method, in a radio communication device, for performing radio measurements on cells on a plurality of carrier frequencies.

FIG. 7 is a block diagram illustrating an alternative view of an example network node.

FIG. 8 is a block diagram illustrating an alternative view of an example radio communication device.

### DETAILED DESCRIPTION

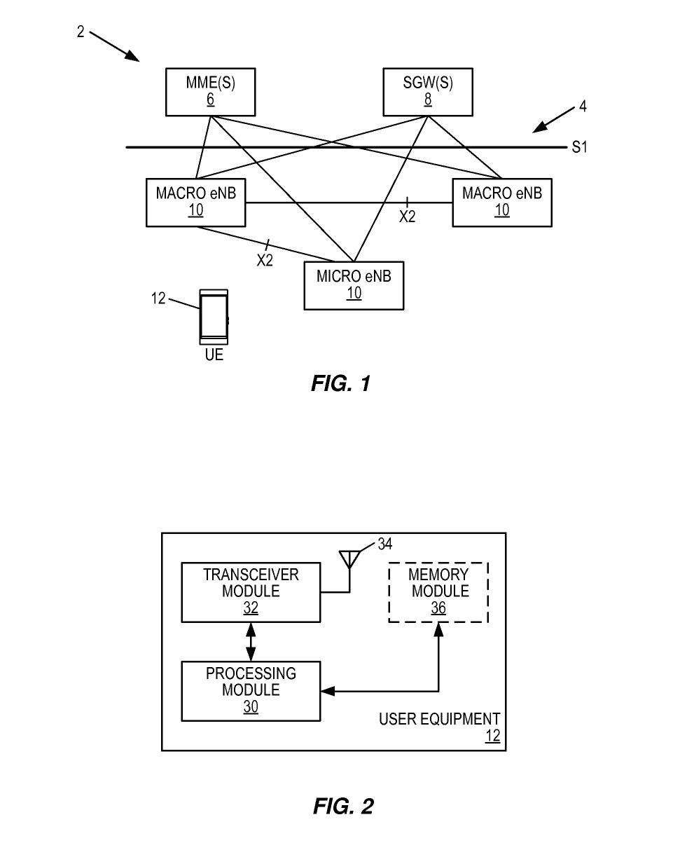

FIG. 1 shows an example diagram of an EUTRAN architecture as part of an LTE-based communications system 2. Nodes in the core network 4 include one or more Mobility Management Entities (MMES) 6, a key control node for the LTE access network, and one or more Serving Gateways (SGWs) 8, which route and forward user data packets while acting as mobility anchors. They communicate with base stations 10, referred to in LTE as eNBs, over a predefined interface, for example an S1 interface. The eNBs 10 in a given network or in a given area can include several of the the same or different categories of eNBs, e.g., macro eNBs, and/or micro/pico/femto eNBs. The eNBs 10 communicate with one another over an interface, for example an X2 interface. The S1 interface and X2 interface are defined in the LTE standard.

A UE 12 can receive downlink data from and send uplink data to one of the base stations 10, with that base station 10 being referred to as the serving base station of the UE 12. It should be appreciated that while the techniques described herein may be applied in the context of an EUTRAN network, e.g., as illustrated in FIG. 1, the techniques may also be applied in other network contexts, including in UTRA networks.

In some of the embodiments described herein, the non-limiting term “user equipment” or “UE” is used. A UE, as that term is used herein, can be any type of wireless device capable of communicating with a network node using radio signals. A UE may also be referred to as a radio communication device, or a target device, and the term is intended to include device-to-device UEs, machine-type UEs or UEs capable of machine-to-machine communication, sensors equipped with a UE, wireless-enabled table computers, mobile terminals, smart phones, laptop-embedded equipped (LEE), laptop-mounted equipment (LME), USB dongles, wireless customer-premises equipment (CPE), etc.

FIG. 2 is a block diagram illustrating elements of an user equipment (UE) 12 that can be used in one or more of the non-limiting example embodiments described. The UE 12 may in some embodiments be a mobile device that is configured for machine-to-machine (M2M) or machine-type communication (MTC). The UE 12 comprises a processing module 30 that controls the operation of the UE 12. The processing module 30, which may comprise one or more microprocessors, microcontrollers, digital signal processors, specialized digital logic, etc., is connected to a receiver or transceiver module 32 with associated antenna(s) 34, which are used to receive signals from or both transmit signals to and receive signals from a base station 10 in the network 2. To make use of discontinuous reception (DRX), the processing module 30 can be configured to deactivate the receiver or transceiver module 32 for specified lengths of time. The user equipment 12 also comprises a memory module 36 that is connected to the processing module 30 and that stores program and other information and data required for the operation of the UE 12. The memory module 36 may comprise one or several types of memory devices, such as read-only memory (ROM) devices, random-access memory (RAM) devices, and/or Flash memory devices. Together, the processing module 30 and memory module 36 may be referred to as a “processing circuit,” and are adapted, in various embodiments, to carry out one or more of the network-based techniques described below.

In the description of some embodiments below, the generic terminology “radio network node” or simply “network node (NW node)” is used. These terms refer to any kind of wireless network node, such as a base station, a radio base station, a base transceiver station, a base station controller, a network controller, an evolved Node B (eNB), a Node B, a relay node, a positioning node, a E-SMLC, a location server, a repeater, an access point, a radio access point, a Remote Radio Unit (RRU) Remote Radio Head (RRH), a multi-standard radio (MSR) radio node such as MSR BS nodes in distributed antenna system (DAS), a SON node, an O&M, OSS, or MDT node, a core network node, an MME, etc.

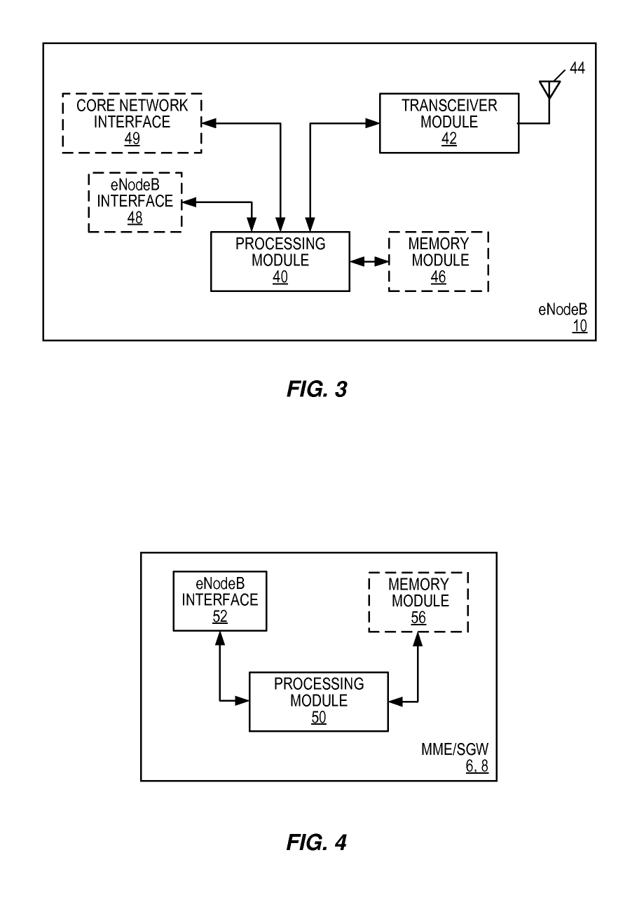

FIG. 3 is a block diagram that illustrates elements of an example base station 10 (for example, a NodeB or an eNodeB) that can be used in example embodiments described in detail herein. It will be appreciated that while a macro eNB will not, in practice, be identical in size and structure to a micro eNB, these base stations 10 may be assumed to include similar components, for the purpose of illustration. Thus, for example, a base station 10 will typically include a processing module 40 that controls the operation of the base station 10, as shown in FIG. 3. The processing module 40, which may comprise one or more microprocessors, microcontrollers, digital signal processors, specialized digital logic, etc., is connected to a transceiver module 42, which has associated antenna(s) 44 which are used to transmit signals to, and receive signals from, user equipments 12 in the network 2. The base station 10 also comprises a memory module 46 that is connected to the processing module 40 and that stores program and other information and data required for the operation of the base station 10. Once again, the memory module 46 may comprise one or several types of memory devices, such as read-only memory (ROM) devices, random-access memory (RAM) devices, and/or Flash memory devices. Together, the processing module 40 and memory module 46 may be referred to as a “processing circuit,” and are adapted, in various embodiments, to carry out one or more of the network-based techniques described below.

The base station 10 also includes components and/or circuitry 48 for allowing the base station 10 to exchange information with other base stations 10 (for example, via an X2 interface) and components and/or circuitry 49 for allowing the base station 10 to exchange information with nodes in the core network 4 (for example, via the S1 interface). It will be appreciated that base stations for use in other types of network (e.g., UTRAN or WCDMA RAN) will include similar components to those shown in FIG. 3 and appropriate interface circuitry 48, 49 for enabling communications with the other network nodes in those types of networks (e.g., other base stations, mobility management nodes and/or nodes in the core network).

FIG. 4 shows a core network node 6, 8 that can be used in the example embodiments described. The node 6, 8 comprises a processing module 50 that controls the operation of the node 6, 8. The processing module 50, which may comprise one or more microprocessors, microcontrollers, digital signal processors, specialized digital logic, etc., is connected to components and/or circuitry 52 for allowing the node 6, 8 to exchange information with the base stations 10 with which it is associated (which is typically via the S1 interface). The node 6, 8 also comprises a memory module 56 that is connected to the processing module 50 and that stores program and other information and data required for the operation of the node 6, 8. Together, the processing module 50 and memory module 56 may be referred to as a “processing circuit,” and may be adapted, in various embodiments, to carry out one or more of the network-based techniques described below.

It will be appreciated that FIGS. 2, 3, and 4 illustrate only those components of the UE 12, base station 10, and core network node 4, 6 that are needed to explain the embodiments presented herein.

A radio measurement is associated with one or more requirements that are to be met by the UE and that may be pre-defined in the specifications for a particular radio-access technology (RAT). There are a number of different types of requirements that associated with a radio measurement. Non-limiting examples of requirements associated with a measurement are: measurement period or measurement time (also known as physical layer measurement period or L1 measurement period), time to identify a cell (also known as cell search delay or PCI acquisition time), time to acquire the cell global identification (CGI) or evolved cell global identification (ECGI) of a cell, measurement reporting delay, measurement accuracy, number of cells on which the UE can perform measurements over the measurement period, a signal level (e.g., CPICH RSCP, RSRP, etc.) down to which a certain requirement is applicable, a signal quality (e.g., CPICH Ec/No, CRS Es/lot, SCH Es/lot, etc.) down to which a certain requirement is applicable, a maximum number or rate of UL and/or DL packet loss on serving cell when performing certain measurement on serving or neighbor cells, etc.

It has been proposed to double the number of carriers that a UE can measure, i.e., to four and six inter-frequency carriers in UTRAN and E-UTRAN respectively. There are several problems associated with increasing the number of inter-frequency or inter-RAT carriers that the UE should measure. With twice as many inter-frequency or inter-RAT carriers as is specified today, the measurement rate in idle mode and other DRX modes will decrease by a factor of two. Therefore, the measurement time or measurement delays when the environment changes will be twice as long. The longer delay is undesirable from a mobility performance point of view. Further, the risk of losing a paging message increases, since mobility between the cell layers will be degraded.

For the connected states, RRC connected state, Cell_DCH and Cell_FACH, there are possibilities to increase the number of measurement gaps, but this lowers throughput, since more time is allocated for measurements. If the rate of gaps is not increased, then the measurement delays will increase and there is a higher risk of losing calls.

If the measurement requirements are changed so that the UE shall measure with the same rate but on several carriers (e.g., twice as many as are currently specified) then there is a bad impact on the UE. In idle mode, the power consumption will increase, due to more radio time spent on performing measurements on the extra carriers. In connected mode, where there is a limited time for measurements, it will be very difficult to increase the rate since, for example, cell detection cannot be done much faster. Also, in connected mode the UE can operate in discontinuous receive (DRX) mode, where measurements on additional carriers within the existing time will also degrade the UE battery life due to an increase in power consumption.

Several of the techniques, devices, and systems described herein provide mechanisms to perform measurements when carriers are increased while overall mobility performance is not degraded. These include, as detailed below, techniques in a network node for configuring carriers for measurements with different requirements, techniques in a UE or other radio communication device of measuring on carriers with different requirements, and techniques for signaling a capability associated with measurements on carriers with different requirements.

### General Description

According to several embodiments of the presently disclosed techniques, a network node, e.g. a BS, eNode B, radio network controller (RNC), etc., configures a UE to perform radio measurements on cells belonging to plurality of carrier frequencies, in parallel. The carriers may belong to the radio-access technology (RAT) of the serving cell or of another RAT, or may belong to a combination thereof (i.e., carriers of both serving RAT and a non-serving RAT or RATs). The term “parallel” here means that the UE has to measure the cells from different carrier frequencies over at least partly overlapping time periods, e.g., partly overlapping measurements over a particular L1 measurement period.

The measurements to be performed by the UE on M different carriers are associated with several different sets of performance requirements. M is typically a number of carriers excluding carriers of serving cells (e.g., excluding PCell and SCells carriers). The measurements are therefore termed herein as class-based measurements and corresponding requirements are termed as class-based requirements. For simplicity, we assume two classes of measurements for explaining the class-based measurement approach in different embodiments, although more than two classes of measurements are possible.

A first class of measurements is performed by the UE on the cells belonging to a first set of carriers (K) and a second class of measurements are performed by the UE on the cells belonging to the second set of carriers (L). However the embodiments are applicable to any number of classes. The first and second classes of measurements are associated with different set of requirements to be met by the UE. Certain requirements pre-defined for the first measurement class are more stringent than those pre-defined for the second measurement class.

A Method in a Network Node of Configuring Carriers Associated with Class-Based Requirements

According to several embodiments of the present techniques, a network node may, prior to configuring a UE to perform radio measurements on cells belonging to a plurality of carrier frequencies, determine the total number of carriers per RAT (mᵢ) and also total carriers across all RATs (M) on whose cells the UE is required to perform measurements. The parameter mᵢ is total number of carriers for RATᵢ. The values of parameters mᵢ and M will generally depend upon the current deployment scenario, e.g., the carriers on which different RATs operate.

If the network node determines that both mᵢ and M are below or equal to certain thresholds aᵢ and b, respectively, then the network node does not have to associate any “measurement class” with any of the carrier frequencies. Examples of a₁ and b are two carriers and seven carriers, respectively, in UTRAN. Examples of a₁ and b are three carriers and seven carriers, respectively, in UTRAN FDD. In the event that both mᵢ and M are below or equal to the thresholds aᵢ and b, the network node uses the legacy measurement approach (i.e., the previously existing solution) and therefore sends measurement configuration message containing information related to carrier frequencies on whose cells the UE shall perform measurements.

On the other hand, if the network node determines that at least one of the values of mᵢ and M is larger than the corresponding thresholds aᵢ and b respectively then the network node associates “measurement classes” with the carrier frequencies before sending the measurement configuration message to the UE.

The network node uses any one or more of the following criteria for determining which carriers should be associated with which measurement class. These determinations are done for UEs in low activity RRC states as well as for UEs in high activity RRC states. The network node may use the same or even different sets of criteria depending upon the activity state of the UE.
Deployment scenario—
   In one embodiment the network node determines the radio network node classes (also known as base station classes) on different carrier frequencies on which the measurements are to be performed by the UE. The BS class may be broadly divided into a high power class (e.g., an “HPN class”) and a low power class (e.g., an “LPN” class). The BS class may even comprise a plurality of classes such as wide area BS serving macro cell, medium range BS serving micro cell, local area BS serving pico cell or home BS serving femto cell or any other low power class such as access point serving indoor or localized area. Typically, a wide area BS class is HPN and remaining ones are considered LPNs. The network node then associates the carriers on which HPNs operate with first measurement class and carriers on which LPNs operate with second measurement class.
   In another example, the network node associates the carriers on which HPNs and certain LPNs (e.g., medium-range LPNs) operate with a first measurement class and carriers on which all remaining LPNs operate with a second measurement class. In yet another example, the network node associates the carriers on which all BS classes except the home BS operate with a first measurement class and carriers on which the home BSs operate with a second measurement class. In still another example, the network node associates the carriers on which all mixture of classes (e.g., HPN and LPN, i.e., co-channel heterogeneous deployment) operate with a first measurement class and carriers on which same type of BSs operate with second measurement class.
Radio operating parameters—
   The network node may also take into account one or more radio operating parameters used in cells on different carriers for deciding the measurement class for different carriers to be measured by the UE. Examples of radio operating parameters used in a cell are cell bandwidth, number of transmit antennas, number of receive antennas, antenna transmission scheme or mode (e.g., open-loop transmit diversity, closed-loop transmit diversity, spatial multiplexing, etc.), frequency band, etc.
   In one example, the network node decides to associate carriers leading to better performance with a first measurement class and the remaining ones with the second measurement class. For example, carriers with cells using larger bandwidth, more antennas, lower frequency band, etc., would lead to better performance (e.g., better user throughput or bit rate, better coverage, etc.). Example of lower frequency bands are bands below 1 GHz. Examples of larger bandwidths are bandwidths larger than or equal to 10 MHz.
Type of RATs—
   The network node may also associate the measurement class with the carriers depending upon the type of RAT on which the carrier operates. In one example, the network node may associate the carriers of serving RAT with the first measurement class whereas carriers of non-serving RATs are associated with the second measurement class. In another example, the network node may associate the carriers of certain RATs as much as possible with the first measurement class whereas carriers of other RATs are associated with the second measurement class. Examples of certain RATs are LTE and HSPA, whereas other RATs could be GSM, CDMA2000, HRPD, WLAN, etc.
Type of Service—
   The network node may also associate the measurement class with the carriers depending upon the type of service the UE is currently in use. Examples of service types are delay sensitive services such as speech or VOIP, background or delay insensitive service such as Internet access, emergency call or service etc. For example if the UE is using delay sensitive services such as speech then the network node associates the carriers on which such services are available with first measurement class, e.g., a RAT which supports CS fall back from E-UTRAN to GSM or HSPA to support voice service. Examples of such RATs are GSM and UTRAN.
UE mobility state—
   The network node may also determine UE mobility state and based on this decides which carriers to associate with which measurement class. Examples of parameters which can be associated with UE mobility state are UE speed, which may be obtained, for example, by measuring Doppler speed of the UE, and the UE's direction of motion, which can be obtained by measuring a direction of arrival of a received signal, for example, such as by using an angle-of arrival measurement performed by the network node or by the serving node. Other example parameters include UE acceleration, which can be measured by observing the change in the UE speed, and UE trajectory, e.g., the UE's overall path of motion. The latter can be represented by two or more set of geographical coordinates along the trajectory followed by the UE.
   For example, if a UE is moving at a higher speed (e.g., more than 30 km/hour) then the network node may associate the carriers of HPNs with a first measurement class to ensure that UE maintains a good connection with a macro carrier frequency. At lower speed, or when static, the network node may even associate carriers with macro cells with the second measurement class.

After determining the association between a carrier frequency and a measurement class using the principles described above, the network node, in some embodiments, tags each carrier frequency with the measurement class identifier, e.g., ID=0 and 1 for the first and second measurement classes respectively. To reduce signaling overhead, the network node may in some embodiments only tag or link carriers with one of the classes (e.g., ID=0), such that untagged carriers are considered to be associated with the other class (e.g., ID=1).

The network node then signals the information about the carrier frequencies and, in some embodiments, their associated measurement classes, to the UE for performing measurements on cells of these carriers. The information can be sent via a broadcast channel, e.g., as part of system information, or on a UE-specific channel such as a shared control channel or a dedicated channel. The information about carrier frequencies is typically, but not necessarily, based on existing information, e.g., frequency channel numbers such as ARFCN, UARFCN, EARFCN, etc.

According to some embodiments, if the network node determines that several carriers have to be associated with a second measurement class, which in turn will degrade performance beyond an acceptable limit or threshold, then the network node may take one of the following actions:
the network node decides to configure total number of carriers not exceeding the threshold (b);
the network node decides to configure total number of carriers per RAT for certain RAT (e.g., RAT₁) not exceeding the threshold (a₁). The selected RAT(s) is the one whose performance (e.g., mobility performance) is more critical and should be maintained above the acceptable limit;
the network node decides to lower the total number of carriers though still exceeding the threshold (b); and
the network node decides to lower the total number of carriers per RAT for certain RAT though still exceeding the threshold (a₁).
   Method in UE of Measuring on Carriers with Different Requirements

According to several embodiments of the present techniques, a UE first determines the association between the measurement classes and different carrier frequencies on which it is requested to perform the measurement. Then the UE starts performing measurements while meeting the relevant requirements. These two steps are elaborated below.

Determination of Association Between Measurement Class and Different Carrier Frequencies—

the UE receives from the network node a measurement configuration message containing information about the plurality of carrier frequencies on whose cells the UE is required to perform one or more types of radio measurements (e.g. RSRP, RSRQ, CPICH RSCP, CPICH Ec/No, GSM carrier RSSI, ECGI reading, CGI reading, etc.). The information may further comprise information about the measurement class associated with all or subset of carrier frequencies.

After retrieving the information received from the network node, the UE determines which of the requirements are to be met when performing measurements on each of the indicated carriers, as described in further detail below. In some embodiments, the UE may also itself (i.e., without network signaling) obtain information about the association between the measurement class and the carrier frequencies based on one or more criteria. The UE may use one or more of the criteria described above (in connection with the network node-based method) for the determination of the association. For example, these criteria can be decided or selected by the UE autonomously or based on one or more pre-defined rules. For instance, it may be pre-defined that the UE performs measurements on carriers with HPNs assuming first measurement class if UE speed is above threshold, e.g., more than 30 km/hour. The UE acquires information about the BS class of BSs deployment on certain carrier from the network node.

Rules for Measurements on Carriers Associated with Different Measurement Classes—

if the UE determines, based on the retrieved information, that none of the carriers is associated with any measurement class, then the UE performs measurements on cells operating on these carriers according to existing requirements. The existing requirements equally scale one or more requirements for all carriers by the same scaling factor. For example, the measurement time (e.g., cell identification time or L1 measurement period) for one or more cells increases linearly with the total number of carriers configured for measurements as follows:
Tmeasure=480 milliseconds*M; where Tmeasure is the measurement period of measuring up to four cells on an LTE carrier; M is the total number of carriers (of all RATs) configured for measured.

If the UE determines, based on the retrieved information, that at least a certain set of the carriers are associated with at least one of the measurement classes, then the UE performs measurements on cells operating on these carriers and meets the requirements associated with their respective class. The UE assumes, based on a pre-defined rule, that the carriers not associated with any measurement class are to be measured according to the measurement class not included in the received information. For example, if only carriers 2, 5 and 6 are tagged with the first measurement class then remaining carriers 1, 3 and 4 are assumed to be associated with the second measurement class. In some embodiments, the UE may also receive complete information about the carriers where each carrier is tagged with a measurement class. In both cases, the UE applies scaling factors to scale the requirements (e.g., measurement time) when performing measurements on carriers according to their associated measurement class. For example, when performing measurements on cells of first set of carriers which are linked to first measurement class, the UE meets first requirements, and when performing measurements on cells of second set of carriers which are linked to first measurement class, the UE meets second requirements, where at least one or more of the first set of requirements are more stringent than the corresponding one or more of the second set of requirements.

Typically, the measurement time, such as cell identification time and measurement period, are scaled differently for different measurement classes. The number of cells to measure on each carrier may also be scaled or weighted differently for different measurement classes. A longer measurement time is considered to be less stringent compared to the case of shorter measurement time. Remaining requirements, such as measurement accuracy (e.g., RSRP accuracy within +/−x dB), for all measurement classes may be the same. This is elaborated with few examples below:
In one example, the measurement time (e.g., cell identification time or L1 measurement period) for one or more cells in a first set of carriers scales with a certain scaling factor (G) configured for measurements, whereas the measurement time (e.g., cell identification time or L1 measurement period) for one or more cells in a second set of carriers scales with another scaling factor (H), where G<H and G and H may also depend upon one or more of the total number of configured carriers for all RATs, total number of configured carriers, etc. This is expressed as follows, for example:
   Tmeasure_first_class=480 milliseconds*G; where Tmeasure_first_class is the measurement period of measuring up to a certain number of cells on an LTE carrier;
   Tmeasure_second_class=480 milliseconds*H; where Tmeasure_second_class is the measurement period of measuring up to a certain number of cells on an LTE carrier.
In another example, the measurement time (e.g., cell identification time or L1 measurement period) for one or more cells on first set of carriers scales with the total number of the first set of carriers (K) (i.e., G=K in above example) configured for measurements, whereas the measurement time (e.g., cell identification time or L1 measurement period) for one or more cells on second set of carriers scales with the overall total number of carriers (M) (i.e., H=M in above example) configured for measurements as below:
   Tmeasure_first_class=480 milliseconds*K; where Tmeasure_first_class is the measurement period of measuring up to a certain number of cells on an LTE carrier;
   Tmeasure_second_class=480 milliseconds*M; where Tmeasure_second_class is the measurement period of measuring up to a certain number of cells on an LTE carrier.
In yet another example, the measurement time or any other requirements (e.g., cell identification time or L1 measurement period) for any measurement may be unequally split for performing measurements on cells of different measurement classes. For example, the available time (T) may be split such that t1/T and t2/T fractions of the total time (T) are used by the UE for performing measurements on the first set of carriers and second set of carriers, respectively. The parameters t1 and t2 and also T may be pre-defined or configured by the network node.

In all of the above examples, the scaling factors or weighting factors to ensure UE meets first or second set of requirements, depending upon the associated classes of the carriers, can be pre-defined or configured by the network node. The above examples for allocating different times depending upon the measurement class may also be pre-defined, in some embodiments.

The above pre-defined rules and signaling information would require the UE to store, receive, retrieve, process and apply the said information to performed the required measurements and meet corresponding requirements. For example, for measuring on cells of first set of carriers the UE will have to obtain measurement samples more often (i.e., perform more frequent sampling) compared to the case when it measures on cells of second set of carriers. The UE may also give higher priority to measuring on first set of carriers in terms of first completing these measurements fully or partially before starting measurements on the second set of carriers.

The UE, after performing one or more measurements using the principles disclosed above, may use the performed measurements for one or more radio resource management tasks or operations. Examples of such tasks are reporting the measurement results (e.g., RSRP/RSRQ measurement results) to the network node or to another UE capable of device-to-device communication. Yet another example is that the UE uses the measurement results for autonomous tasks such as for doing cell selection, cell reselection, storing results as part of MDT and reporting to network node when establishing connection with the network node etc.

Method in UE of Signaling Capability Associated with Measurements on Carriers with Different Requirements

All UEs may not be capable of performing class-based measurements on plurality of carrier frequencies. Therefore, according to some embodiments, a UE that is capable of performing measurements on cells belonging to carriers associated with different requirements corresponding to their respective measurement class may also inform the network node that it supports this capability. The UE may report the capability to the network node via RRC signaling (e.g., to eNB, RNC, BSC etc). The UE may also signal the capability to other nodes, such as a positioning node (e.g., an E-SMLC, a location server, etc.), using the LTE positioning protocol (LPP), for example. The UE may also include additional information in the capability message, the additional information comprising one or more of the following:
an indication that the UE is capable of performing class-based measurements on different carriers only for certain RATs, e.g., UTRAN FDD, LTE;
an indication that the UE is capable of performing class-based measurements on different carriers only for certain frequency bands;
an indication that the UE is capable of performing class-based measurements on different carriers only depending upon the total number of carriers and/or total number of carriers per RAT;
an indication that the UE is capable of performing class-based measurements on different carriers only for certain types of measurements, e.g., mobility measurements, positioning measurements, etc.; and
an indication that the UE is capable of performing class-based measurements on different carriers only in one or more particular RRC activity states, e.g., in connected state, CELL_DCH state, CELL_FACH state, etc.

The acquired capability information may be used by the receiving network node and/or positioning node for taking one or more radio operation tasks or radio resource management actions. Examples of radio operation tasks are a decision whether to configure the UE with several carriers (e.g., more than seven carriers in total) for doing measurements, whether to associate the carriers with the measurement class or not, etc.

The UE may send the capability information to the network node and/or positioning node in any of the following manner:
proactive reporting, without receiving any explicit request from the network node (e.g., a serving node or any target network node);
reporting upon receiving any explicit request from the network node (e.g., a serving node or any target network node);
   Note that an explicit request can be sent to the UE by the network any time or at any specific occasion. For example, a request for the capability reporting can be sent to the UE during initial setup or after a cell change (e.g., handover, RRC connection re-establishment, RRC connection release with redirection, PCell change in carrier aggregation (CA), primary component carrier (PCC) change in CA, etc.).

In case of proactive reporting the UE may report its capability during one or more of the following occasions, for example:
during initial setup or call setup, e.g., when establishing the RRC connection;
during a cell change, e.g., handover, primary carrier change in multi-carrier operation, PCell change in multi-carrier operation, RRC re-establishment, RRC connection release with redirection, etc.

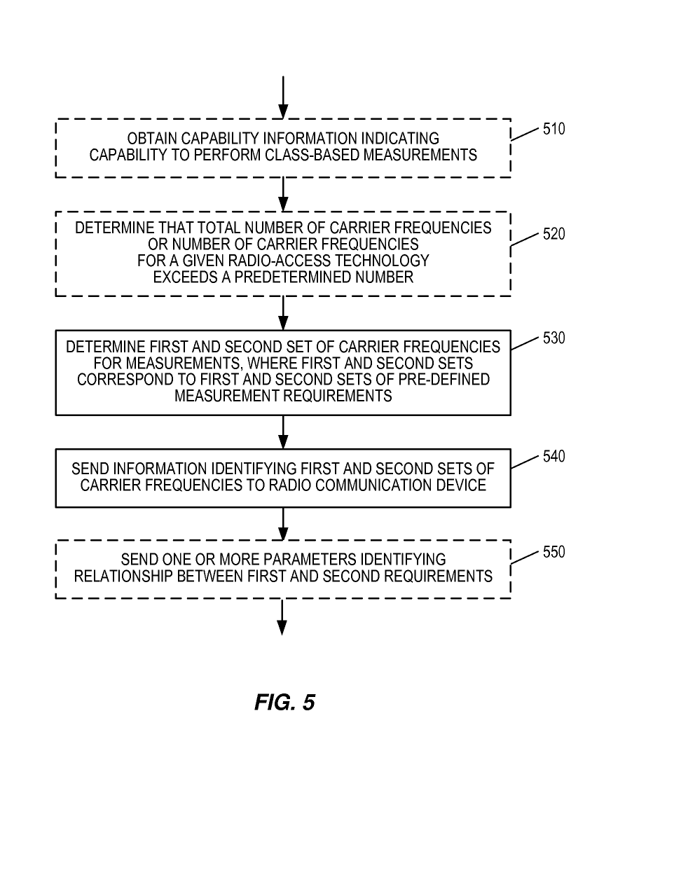

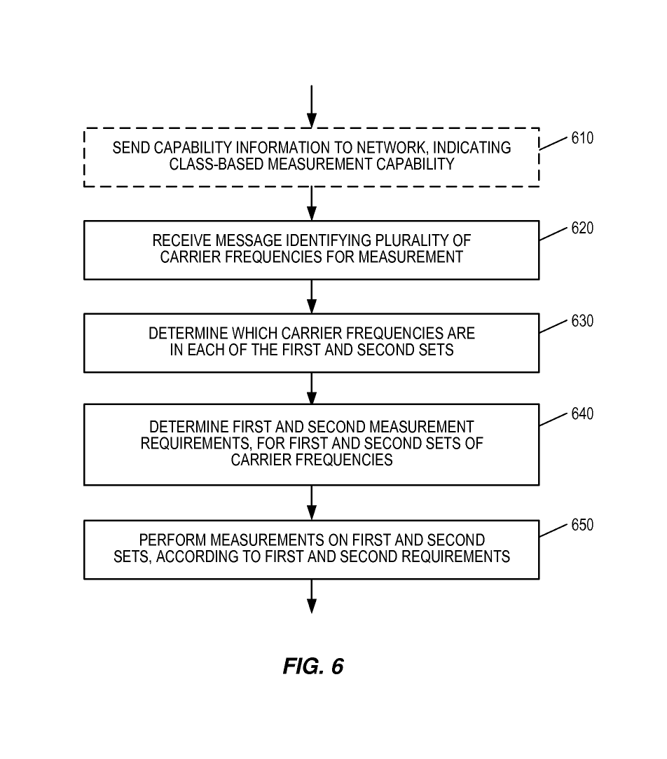

With the above detailed techniques in mind, it will be appreciated that FIGS. 5 and 6 illustrate example methods suitable for implementation in a network node (such as the base station of FIG. 3 or the core network node shown in FIG. 4) and in a radio communication device (such as the UE shown in FIG. 2), respectively.

The method shown in FIG. 5 may be implemented in a network node (e.g., a base station, a radio base station, a base transceiver station, an evolved Node B (eNB), a Node B, a relay node or a positioning node) and is for configuring a radio communication device (e.g., a UE, a wireless device, a mobile terminal) for performing radio measurements on cells on plurality of carrier frequencies. Referring to FIG. 5 and skipping blocks 510 and 520 for a moment, the illustrated example method includes, as shown at block 530, determining at least first and second sets of carrier frequencies to be used by the radio communication device for performing radio measurements on cells operating on the said carrier frequencies, where radio measurements to be performed on cells on the first set of carrier frequencies are required to meet at least a first measurement requirement and radio measurements of the same type performed on cells on the second set of carrier frequencies are required to meet at least a corresponding second measurement requirement. As discussed above, the first measurement requirement is more stringent than the second measurement. In some embodiments or instances, the first and second sets each include at least one carrier frequency for each of at least two radio-access technologies.

As shown at block 540, the method further includes sending information to the radio communication device, the information identifying the determined first and second sets of carrier frequencies. This enables the radio communication device to perform class-based measurements on cells operating on the carrier frequencies in said sets.

In some embodiments and/or in some instances, the determining and sending shown in blocks 530 and 540 are performed in response to determining, as shown at block 520, that a total number of carrier frequencies to be used for performing radio measurements exceeds a predetermined maximum number of carrier frequencies. Alternatively, in some other embodiments and/or instances, the determining and sending of blocks 530 and 540 are performed in response to determining that a number of carrier frequencies to be used for performing radio measurements and corresponding to a first radio-access technology exceeds a predetermined maximum number for carrier frequencies corresponding to the first radio-access technology. This is also shown in block 520.

As was discussed in detail above, in various embodiments, the first and second measurement requirements define differing values for any one of the following: a measurement period; a measurement reporting delay; a time to identify a cell; a number of cells on which the UE can perform measurements over the measurement period; a measurement accuracy; a signal level down to which an additional measurement requirement is applicable; a signal quality down to which an additional measurement requirement is applicable; and a permissible rate of packet loss or permissible number of lost packets when performing measurements.

In some embodiments, the determining of the first and second sets of carrier frequencies includes assigning carrier frequencies to the first and second sets of carrier frequencies at least partly based on whether each carrier frequency is associated with a first or second radio network node power class. For example, the first radio network node power class may correspond to a higher transmitter power than the second radio network node power class. In some of these and in some other embodiments, carrier frequencies are assigned to the first and second sets of carrier frequencies at least partly based on one or more of the following characteristics of the cells corresponding to the carrier frequencies: cell bandwidth; number of transmitter antennas; number of receiver antennas; supported multi-antenna transmission schemes; and frequency band.

In some embodiments, determining the first and second sets of carrier frequencies includes assigning carrier frequencies to the first and second sets of carrier frequencies at least partly based on a type of service being provided to the radio communication device. In some embodiments, carrier frequencies are assigned to the first and second sets of carrier frequencies at least partly based on a mobility state for the radio communication device.

In some embodiments, as shown at block 550, the network node further sends, to the radio communication device, one or more parameters identifying a relationship between the first and second measurement requirements. These one or more parameters may include an indication of a scaling factor that defines a relation (e.g., a ratio) between the first and second measurement requirements. In some embodiments, the one or more parameters may indicate a weighting factor to the radio communication device, the weighting factor defining an allocation of measurement time between measurements for the first set of first carrier frequencies and measurements for the second set of carrier frequencies.

In some embodiments, the operations shown in blocks 530 and 540 are conditioned on the obtaining of capability information indicating that the radio communication device is capable of performing class-based measurements. This obtaining, which may be via signaling sent from the radio communication device, for example, is shown in block 510 of FIG. 5.

FIG. 6 illustrates another example method, which is implemented in a radio communication device (e.g. UE, wireless device, mobile terminal) and which is for performing radio measurements on cells on a plurality of carrier frequencies. As shown at block 620, the illustrated method includes receiving, from a network node, a message identifying a plurality of carrier frequencies for cells that are to be measured by the radio communication device. As shown at block 630, the method further includes determining which carriers are in each of first and second sets of carrier frequencies; as will be discussed in further detail below, this may be based on an explicit identification of one or both of the sets in the signaling received from the network node, in some embodiments, or based on pre-defined rules known to the radio communication device, in others. In some embodiments or instance, the first and second sets each include at least one carrier frequency for each of at least two radio-access technologies.

As shown at block 640, the method further includes determining a first measurement requirement to be met for performing radio measurements on cells operating on the first set of the carrier frequencies and a corresponding second measurement requirement to be met for performing radio measurements of the same type on cells operating on the second set of the carrier frequencies, the first measurement requirement being more stringent than the second measurement requirement. As shown at block 650, measurements are then performed on cells for the first and second sets of carrier frequencies, according to the first and second measurement requirements, respectively.

In various embodiments, the first and second measurement requirements define differing values for any one of the following: a measurement period; a measurement reporting delay; a time to identify a cell; a number of cells on which the UE can perform measurements over the measurement period; a measurement accuracy; a signal level down to which an additional measurement requirement is applicable; a signal quality down to which an additional measurement requirement is applicable; and a permissible rate of packet loss or permissible number of lost packets when performing measurements.

In some embodiments, the determining of which carrier frequencies are in each of the first and second sets may be based on one or more characteristics of at least some of the carrier frequencies and a predetermined rule associating the one or more characteristics to the first and second sets. Determining which carrier frequencies are in each of the first and second sets may be further based on a mobility state for the radio communication device, in some embodiments. In some embodiments, the radio communication device may receive information indicating the one or more characteristics of at least some of the carrier frequencies from the network node.

In some of these and in some other embodiments, the determining of which carrier frequencies are in each of the first and second sets is at least partly based on a type of service being provided to the radio communication device. In other embodiments, determining which carrier frequencies are in each of the first and second sets is instead based on an identification of at least one of the first and second sets included in the message received from the network node.

Determining the first and second measurement requirements, in some embodiments, comprises retrieving predetermined first and second measurement requirements associated with the first and second sets, respectively. In some embodiments, a scaling factor is applied to one of the first and second measurement requirements to obtain the other measurement requirement. In others, a first scaling factor and a second scaling factor are each applied to a base measurement requirement to obtain the first and second measurement requirements. In some of these embodiments, the scaling factor or factors may be received from the network node.

In other embodiments, determining the first and second measurement requirements comprises applying a weighting factor to determine an allocation of measurement time between measurements for the first set of first carrier frequencies and measurements for the second set of carrier frequencies. This weighting factor may be received from the network node, in some embodiments.

Ins some embodiments, the radio communication device may be configured to send capability information to the network node, the capability information indicating that the radio communication device is capable of performing class-based measurements in which radio measurements to be performed on cells of a first class are required to meet at least the first measurement requirement while radio measurements to be performed on cells of a second class are required to meet at least the second measurement requirement. This sending operation is illustrated in block 610 of FIG. 6.

It should be appreciated that the methods illustrated in FIGS. 5 and 6, and variants thereof, may be implemented using the processing circuits illustrated in FIGS. 2, 3, and 4, where the processing circuits are configured, e.g., with appropriate program code stored in memory circuits 36, 46, and/or 56, to carry out the operations described above. While some of these embodiments are based on a programmed microprocessor or other programmed processing element, it will be appreciated that not all of the steps of these techniques are necessarily performed in a single microprocessor or even in a single module. Embodiments of the presently disclosed techniques further include computer program products for application in a user terminal as well as corresponding computer program products for application in a base station apparatus.

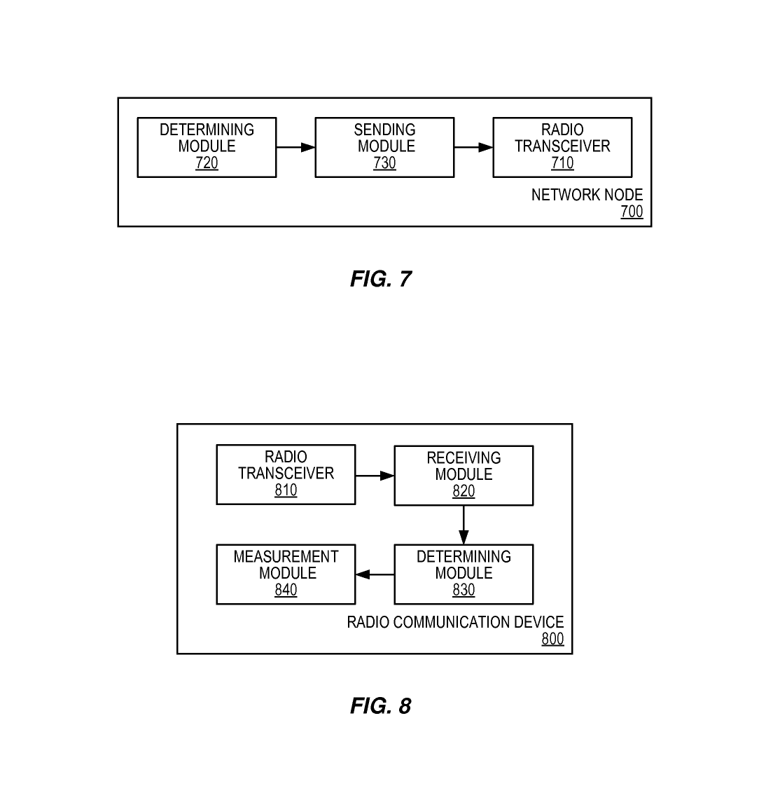

It will further be appreciated that various aspects of the above-described embodiments can be understood as being carried out by functional “modules,” which may be program instructions executing on an appropriate processor circuit, hard-coded digital circuitry and/or analog circuitry, or appropriate combinations thereof. FIGS. 7 and 8 thus illustrate an example network node 700 and radio communication device 800, respectively, where the details of the circuit are represented as functional modules. It will be appreciated that node 700 and radio communication device 800 may be implemented using hardware architectures like those shown in FIGS. 2 and 3, in some embodiments.

FIG. 7 thus illustrates an example network node 700 comprising a radio transceiver 710 configured to communicate with a radio communication device and a determining module 720 configured to determine at least first and second sets of carrier frequencies to be used by the radio communication device for performing radio measurements on cells operating on the said carrier frequencies, where radio measurements to be performed on cells on the first set of carrier frequencies are required to meet at least a first measurement requirement and radio measurements of the same type performed on cells on the second set of carrier frequencies are required to meet at least a corresponding second measurement requirement, the first measurement requirement being more stringent than the second measurement requirement. The network node 700 further comprises a sending module configured to send information to the radio communication device, using the radio transceiver, the information identifying the determined first and second sets of carrier frequencies, thereby enabling the radio communication device to perform class-based measurements on cells operating on the carrier frequencies in said sets. It will be appreciated that all of the variations described above, e.g., in connection with describing the method illustrated in FIG. 5, are applicable to the network node 700 shown in FIG. 7.

Similarly, FIG. 8 provides an alternative view of a radio communication device 800, which is adapted to perform radio measurements on cells on a plurality of carrier frequencies. Radio communication device 800 includes a radio transceiver 810 configured to communicate with a network node and a receiving module 820 configured to receive from the network node, via the radio transceiver 810, a message identifying a plurality of carrier frequencies for cells that are to be measured by the radio communication device. Radio communication device 800 further includes a determining module 830 configured to determine a first measurement requirement to be met for performing radio measurements on cells operating on a first set of the carrier frequencies and a corresponding second measurement requirement to be met for performing radio measurements of the same type on cells operating on a second set of the carrier frequencies, the first measurement requirement being more stringent than the second measurement requirement. Finally, radio communication device 800 includes a measurement module 840 configured to perform measurements on cells for the first and second sets of carrier frequencies, according to the first and second measurement requirements, respectively, using radio signals received via the radio transceiver. Again, the variations described above, including those discussed in connection with the method shown in FIG. 6, are equally applicable to the radio communication device 800 of FIG. 8.

It will be appreciated by the person of skill in the art that various modifications may be made to the above described embodiments without departing from the scope of the presently disclosed techniques and apparatus. For example, it will be readily appreciated that although the above embodiments are described with reference to parts of a 3GPP network, embodiments will also be applicable to like networks, such as a successor of the 3GPP network, having like functional components. Therefore, in particular, the terms 3GPP and associated or related terms used in the above description and in the enclosed drawings and any appended claims now or in the future are to be interpreted accordingly.

Examples of several embodiments have been described in detail above, with reference to the attached illustrations of specific embodiments. Because it is not possible, of course, to describe every conceivable combination of components or techniques, those skilled in the art will appreciate that the present techniques and apparatus can be implemented in other ways than those specifically set forth herein, without departing from their essential characteristics. The present embodiments are thus to be considered in all respects as illustrative and not restrictive.

With these and other variations and extensions in mind, those skilled in the art will appreciate that the foregoing description and the accompanying drawings represent non-limiting examples of the systems and apparatus taught herein for supporting class-based measurements in radio communication devices. As such, the presently disclosed techniques and apparatus are not limited by the foregoing description and accompanying drawings, but are limited only by the following claims and their legal equivalents.

1-40. (canceled)

41. A method, in a network node, of configuring a radio communication device for performing radio measurements on cells on a plurality of carrier frequencies, the method comprising:
determining at least first and second sets of carrier frequencies to be used by the radio communication device for performing radio measurements on cells operating on the said carrier frequencies, wherein radio measurements to be performed on cells on the first set of carrier frequencies are required to meet at least a first measurement requirement and radio measurements of the same type performed on cells on the second set of carrier frequencies are required to meet at least a corresponding second measurement requirement, the first measurement requirement being more stringent than the second measurement requirement; and
sending information to the radio communication device, the information identifying the determined first and second sets of carrier frequencies, thereby enabling the radio communication device to perform class-based measurements on cells operating on the carrier frequencies in said sets.

42. The method of claim 41, wherein said determining and said sending are performed in response to determining that a total number of carrier frequencies to be used for performing radio measurements exceeds a predetermined maximum number of carrier frequencies.

43. The method of claim 41, wherein said determining and said sending are performed in response to determining that a number of carrier frequencies to be used for performing radio measurements and corresponding to a first radio-access technology exceeds a predetermined maximum number for carrier frequencies corresponding to the first radio-access technology.

44. The method of claim 41, wherein the first and second measurement requirements define differing values for any one of the following:
a measurement period;
a measurement reporting delay;
a time to identify a cell;
a number of cells on which the UE can perform measurements over the measurement period;
a measurement accuracy;
a signal level down to which an additional measurement requirement is applicable;
a signal quality down to which an additional measurement requirement is applicable; and
a permissible rate of packet loss or permissible number of lost packets when performing measurements.

45. The method of claim 41, wherein the first and second sets each include at least one carrier frequency for each of at least two radio-access technologies.

46. The method of claim 41, wherein determining the first and second sets of carrier frequencies comprises assigning carrier frequencies to the first and second sets of carrier frequencies at least partly based on whether each carrier frequency is associated with a first or second radio network node power class, the first radio network node power class corresponding to a higher transmitter power than the second radio network node power class.

47. The method of claim 41, wherein determining the first and second sets of carrier frequencies comprises assigning carrier frequencies to the first and second sets of carrier frequencies at least partly based on one or more of the following characteristics of the cells corresponding to the carrier frequencies:
cell bandwidth;
number of transmitter antennas;
number of receiver antennas;
supported multi-antenna transmission schemes; and
frequency band.

48. The method of claim 41, wherein determining the first and second sets of carrier frequencies comprises assigning carrier frequencies to the first and second sets of carrier frequencies at least partly based on a type of service being provided to the radio communication device.

49. The method of claim 41, wherein determining the first and second sets of carrier frequencies comprises assigning carrier frequencies to the first and second sets of carrier frequencies at least partly based on a mobility state for the radio communication device.

50. The method of claim 41, further comprising sending, to the radio communication device, one or more parameters identifying a relationship between the first and second measurement requirements.

51. The method of claim 50, wherein sending one or more parameters identifying a relationship between the first and second measurement requirements comprises sending an indication of a scaling factor to the radio communication device, the scaling factor defining a relation between the first and second measurement requirements.

52. The method of claim 50, wherein sending one or more parameters identifying a relationship between the first and second measurement requirements comprises sending an indication of a weighting factor to the radio communication device, the weighting factor defining an allocation of measurement time between measurements for the first set of first carrier frequencies and measurements for the second set of carrier frequencies.

53. The method of claim 41, further comprising obtaining capability information for the radio communication device, wherein the determining of the first and second sets and sending of the information is conditioned on the obtained capability information indicating that the radio communication device is capable of performing class-based measurements.

54. A method, in a radio communication device, for performing radio measurements on cells on a plurality of carrier frequencies, the method comprising:
receiving, from a network node, a message identifying a plurality of carrier frequencies for cells that are to be measured by the radio communication device;
determining a first measurement requirement to be met for performing radio measurements on cells operating on a first set of the carrier frequencies and a corresponding second measurement requirement to be met for performing radio measurements of the same type on cells operating on a second set of the carrier frequencies, the first measurement requirement being more stringent than the second measurement requirement; and
performing measurements on cells for the first and second sets of carrier frequencies, according to the first and second measurement requirements, respectively.

55. The method of claim 54, wherein the first and second measurement requirements define differing values for any one of the following:
a measurement period;
a measurement reporting delay;
a time to identify a cell;
a number of cells on which the UE can perform measurements over the measurement period;
a measurement accuracy;
a signal level down to which an additional measurement requirement is applicable;
a signal quality down to which an additional measurement requirement is applicable; and
a permissible rate of packet loss or permissible number of lost packets when performing measurements.

56. The method of claim 54, further comprising determining which carrier frequencies are in each of the first and second sets based on one or more characteristics of at least some of the carrier frequencies and a predetermined rule associating the one or more characteristics to the first and second sets.

57. The method of claim 56, wherein determining which carrier frequencies are in each of the first and second sets is further based on a mobility state for the radio communication device.

58. The method of claim 56, further comprising receiving information indicating the one or more characteristics of at least some of the carrier frequencies from the network node.

59. The method of claim 54, further comprising determining which carrier frequencies are in each of the first and second sets at least partly based on a type of service being provided to the radio communication device.

60. The method of claim 54, further comprising determining which carrier frequencies are in each of the first and second sets based on an identification of at least one of the first and second sets included in the message received from the network node.

61. The method of claim 54, wherein determining the first and second measurement requirements comprises retrieving predetermined first and second measurement requirements associated with the first and second sets, respectively.

62. The method of claim 54, wherein determining the first and second measurement requirements comprises applying a scaling factor to one of the first and second measurement requirements to obtain the other measurement requirement.

63. The method of claim 62, further comprising receiving the scaling factor from the network node.

64. The method of claim 54, wherein determining the first and second measurement requirements comprises applying a first scaling factor and a second scaling factor to a base measurement requirement, respectively.

65. The method of claim 54, further comprising sending capability information to the network node, the capability information indicating that the radio communication device is capable of performing class-based measurements in which radio measurements to be performed on cells of a first class are required to meet at least the first measurement requirement while radio measurements to be performed on cells of a second class are required to meet at least the second measurement requirement.

66. A network node arranged to configure a radio communication device for performing radio measurements on cells on a plurality of carrier frequencies, the network node comprising:
means for determining at least first and second sets of carrier frequencies to be used by the radio communication device for performing radio measurements on cells operating on the said carrier frequencies, wherein radio measurements to be performed on cells on the first set of carrier frequencies are required to meet at least a first measurement requirement and radio measurements of the same type performed on cells on the second set of carrier frequencies are required to meet at least a corresponding second measurement requirement, the first measurement requirement being more stringent than the second measurement requirement; and
means for sending information to the radio communication device, the information identifying the determined first and second sets of carrier frequencies, thereby enabling the radio communication device to perform class-based measurements on cells operating on the carrier frequencies in said sets.

67. The network node of claim 66, wherein the means for determining at least first and second sets of carrier frequencies and the means for sending information are configured to carry out said determining and said sending in response to a determination that a total number of carrier frequencies to be used for performing radio measurements exceeds a predetermined maximum number of carrier frequencies.

68. The network node of claim 66, wherein the means for determining at least first and second sets of carrier frequencies and the means for sending information are configured to carry out said determining and said sending in response to a determination that a number of carrier frequencies to be used for performing radio measurements and corresponding to a first radio-access technology exceeds a predetermined maximum number for carrier frequencies corresponding to the first radio-access technology.

69. The network node of claim 66, wherein the means for determining the first and second sets of carrier frequencies is configured to assign carrier frequencies to the first and second sets of carrier frequencies at least partly based on one or more of the following characteristics of the cells corresponding to the carrier frequencies:
a power class for the radio network node providing the cell;
cell bandwidth;
number of transmitter antennas;
number of receiver antennas;
supported multi-antenna transmission schemes; and
frequency band.

70. The network node of claim 66, wherein the means for sending information is further configured to send an indication of a scaling factor to the radio communication device, the scaling factor defining a relation between the first and second measurement requirements.

71. A radio communication device arranged to perform radio measurements on cells on a plurality of carrier frequencies, the radio communication device comprising:
means for receiving, from a network node, a message identifying a plurality of carrier frequencies for cells that are to be measured by the radio communication device;
means for determining a first measurement requirement to be met for performing radio measurements on cells operating on a first set of the carrier frequencies and a corresponding second measurement requirement to be met for performing radio measurements of the same type on cells operating on a second set of the carrier frequencies, the first measurement requirement being more stringent than the second measurement requirement; and
means for performing measurements on cells for the first and second sets of carrier frequencies, according to the first and second measurement requirements, respectively.

72. The radio communication device of claim 71, further comprising means for determining which carrier frequencies are in each of the first and second sets based on one or more characteristics of at least some of the carrier frequencies and a predetermined rule associating the one or more characteristics to the first and second sets.

73. The radio communication device of claim 71, wherein the means for determining which carrier frequencies are in each of the first and second sets is configured to determine which carrier frequencies are in each of the first and second sets at least partly based on a type of service being provided to the radio communication device.

74. The radio communication device of claim 71, wherein the means for determining which carrier frequencies are in each of the first and second sets is configured to determine which carrier frequencies are in each of the first and second sets based on an identification of at least one of the first and second sets included in the message received from the network node.

75. The radio communication device of claim 71, wherein the means for determining the first and second measurement requirements is configured to apply a scaling factor to one of the first and second measurement requirements to obtain the other measurement requirement.

76. The radio communication device of claim 75, wherein the means for receiving is further configured to receive the scaling factor from the network node.

77. A network node adapted to configure a radio communication device for performing radio measurements on cells on a plurality of carrier frequencies, the network node comprising a radio transceiver configured to communicate with the radio communication device and further comprising a processing circuit adapted to:
determine at least first and second sets of carrier frequencies to be used by the radio communication device for performing radio measurements on cells operating on the said carrier frequencies, wherein radio measurements to be performed on cells on the first set of carrier frequencies are required to meet at least a first measurement requirement and radio measurements of the same type performed on cells on the second set of carrier frequencies are required to meet at least a corresponding second measurement requirement, the first measurement requirement being more stringent than the second measurement requirement; and
send information to the radio communication device, using the radio transceiver, the information identifying the determined first and second sets of carrier frequencies, thereby enabling the radio communication device to perform class-based measurements on cells operating on the carrier frequencies in said sets.

78. A radio communication device adapted to perform radio measurements on cells on a plurality of carrier frequencies, the radio communication device comprising a radio transceiver configured to communicate with a network node and further comprising a processing circuit adapted to:
receive from the network node, via the radio transceiver, a message identifying a plurality of carrier frequencies for cells that are to be measured by the radio communication device;
determine a first measurement requirement to be met for performing radio measurements on cells operating on a first set of the carrier frequencies and a corresponding second measurement requirement to be met for performing radio measurements of the same type on cells operating on a second set of the carrier frequencies, the first measurement requirement being more stringent than the second measurement requirement; and
perform measurements on cells for the first and second sets of carrier frequencies, according to the first and second measurement requirements, respectively, using radio signals received via the radio transceiver.

79. A network node adapted to configure a radio communication device for performing radio measurements on cells on a plurality of carrier frequencies, the network node comprising:
a radio transceiver configured to communicate with the radio communication device:
a determining module configured to determine at least first and second sets of carrier frequencies to be used by the radio communication device for performing radio measurements on cells operating on the said carrier frequencies, wherein radio measurements to be performed on cells on the first set of carrier frequencies are required to meet at least a first measurement requirement and radio measurements of the same type performed on cells on the second set of carrier frequencies are required to meet at least a corresponding second measurement requirement, the first measurement requirement being more stringent than the second measurement requirement; and
a sending module configured to send information to the radio communication device, using the radio transceiver, the information identifying the determined first and second sets of carrier frequencies, thereby enabling the radio communication device to perform class-based measurements on cells operating on the carrier frequencies in said sets.

80. A radio communication device adapted to perform radio measurements on cells on a plurality of carrier frequencies, the radio communication device comprising:
a radio transceiver configured to communicate with a network node:
a receiving module configured to receive from the network node, via the radio transceiver, a message identifying a plurality of carrier frequencies for cells that are to be measured by the radio communication device;
a determining module configured to determine a first measurement requirement to be met for performing radio measurements on cells operating on a first set of the carrier frequencies and a corresponding second measurement requirement to be met for performing radio measurements of the same type on cells operating on a second set of the carrier frequencies, the first measurement requirement being more stringent than the second measurement requirement; and
a measurement module configured to perform measurements on cells for the first and second sets of carrier frequencies, according to the first and second measurement requirements, respectively, using radio signals received via the radio transceiver.
